(19) United States
(12) Patent Application Publication
(10) Pub. No.: US 2014/0352260 A1
(43) Pub. Date: Dec. 4, 2014

(54) DETERGENT PACKING

(71) Applicant: The Procter & Gamble Company, Cincinnati, OH (US)

(72) Inventor: Raffaele PINNA, Brussels (BE)

(73) Assignee: The Procter & Gamble Company, Cincinnati, OH (US)

(21) Appl. No.: 14/292,952

(22) Filed: Jun. 2, 2014

(30) Foreign Application Priority Data
Jun. 4, 2013 (EP) 13170522.0

(51) Int. Cl. B65B 63/08; C11D 17/04; B65B 3/04

(52) U.S. Cl. CPC B65B 63/08; B65B 3/04; C11D 17/047
USPC 53/440

(57) ABSTRACT

A process for packing a detergent composition in a container wherein the process comprises the steps of:
a. making the detergent composition in the form of a finished single fluid or a finished plurality of fluids;
b. cooling the finished single fluid or at least one finished fluid of the plurality of fluids to produce a cold fluid;
c. delivering the cold fluid resulting from step b) into the container using delivering means; and optionally
d. subjecting the filled container resulting from step c) to ambient temperature.

### TECHNICAL FIELD

The present invention is in the field of packing. In particular, it relates to the packing of detergents, more in particular detergents in fluid forms. Specifically, it relates to a process for packing a detergent involving a cooling step. The process is especially advantageous in the case of packing low viscosity fluids.

### BACKGROUND OF THE INVENTION

The production of detergent products involves not only the manufacture of the detergent per se but also the packing. As simple as it might appear the packing of detergents can be a complex issue, in particular in the case of liquid detergents.

Low viscosity fluids are attractive from an ease of dosing view point, in particular when dosing is to be done by hand squeezing the container. Low viscosity also contributes to improve dissolution in the case in which the fluid is to be used in diluted form. Low viscosity fluids can be Newtonian or non-Newtonian fluids that present low viscosity under filling conditions (high shear).

The packing of low viscosity fluids can have associated issues such as the incorporation of air and splashing of the fluid during packing. Incorporation of air can take place when the fluid is being dosed into the corresponding container. Once air is entrapped is extremely difficult to remove it. Entrapped air can negatively affect the microbiological stability of detergents. Splashing would require cleaning of the packing lines that would add to the cost. Splashing could be addressed by slowing down the packing speed which in turn would decrease productivity and add to the packing cost. Splashing could also be addressed by increasing the diameter of the aperture of the container to be filled but usually the aperture has a fixed diameter determined by delivery constrains. Detergents can have the additional problem of foam formation during filling that can result on under filling or spilling.

A plurality of separated fluids which keep their identity when packed in a single container can be very aesthetically pleasant. They can also provide the advantage of separation of incompatible ingredients. In addition to the issues highlighted before a further challenger is to avoid mixing of fluids with one another during packing and storage, this is more acute when the fluids have low viscosity. In theory this could be addressed by increasing the viscosity however, this will impact on the dosing and dissolution of the product.

An objective of the present invention is to provide a packing process that ameliorates aeration, splashing and foam formation of fluids. A further objective is to provide a process that reduces the mixing of different fluids packed in a single container.

### SUMMARY OF THE INVENTION

The present invention is related to a process for packing a detergent composition. The first step of the process is to make the detergent composition, this step preferably takes place at ambient temperature. The detergent can be in the form of a single fluid or in the form of a plurality of fluids. By “plurality of fluids” is herein understood two or more distinct fluids, i.e. fluids that differ in at least one component. In the majority of cases the fluids are visually distinct. Each of the fluids of the plurality of fluids is delivered separately, preferably from different vessels, and simultaneously or at different times, and each keeps its identity by no considerably mixing with one another. The plurality of fluids together forms the detergent composition.

The purpose of the invention is to alter the rheology of the fluid or fluids by cooling to obtain the desired benefits. Preferably the fluid is made at ambient temperature (i.e. without active heating) and followed by cooling to such a degree that provides the sought benefits (reduction of aeration, splashing and foaming in the case of single fluids and additional reduction of intermixing in the case of a plurality of fluids).

By “finished” fluid is herein meant a fluid that is ready to be packed. For the purpose of this invention “finished” fluid can include or exclude the presence of minors. By minors is herein meant ingredients that are present in the detergent composition in a level of less than 3% by weight of the composition, preferably less than 2% and especially less than 1% and even more especially less than 0.5% by weight of the composition. Minors can be added to the finished fluid before or after cooling because they usually do not have a marked effect on rheology. Typical minors, include enzyme, perfumes, dyes, etc. Preferably minors are added to the “finished” fluid before cooling. The option of adding minors to the “finished” fluid after cooling is also herein envisaged.

The detergent making step produces a finished single fluid or a plurality of finished fluids. This step is followed by a cooling step to produce a cold fluid. By “cooling” is herein meant that the temperature of the finished fluid is actively reduced to achieve a viscosity reduction that would give rise to the benefits of the invention. Temperature reduction usually takes place by engineering intervention. The temperature reduction can be achieved by subjecting the finished fluid to any cooling means such as a heat exchanger. Preferably, the temperature of the finished fluid is reduced by at least 2° C., more preferably at least 5° C. and especially at least 10° C. Preferably the finished fluid is at ambient temperature before being subjected to cooling. Preferably the temperature of the finished fluid is reduced by at least 2° C., more preferably at least 5° C. and especially at least 10° C. below ambient temperature. By “cold” fluid is herein meant a finished fluid which temperature has been lowered by preferably at least 2° C., more preferably at least 5° C. and especially at least 10° C., preferably from the finished temperature. Preferably from ambient temperature. For the purpose of the present invention ambient temperature is the temperature at which the making of the detergent composition takes place. It does not involve active heating. Preferably ambient temperature ranges from 15° C.-25° C.

Cooling would temporary alter the rheology of the fluid and it is this alteration what would provide a more convenient rheological profile, ameliorating or even avoiding the problems mentioned herein before. Without being bound by theory, it is believed that cooling would contribute to an increase in viscosity thereby reducing air entrapment and splashing; and intermixing during the filling of the container and storage, in the case of a plurality of fluids.

The cooling step is followed by a delivery step, in which the cold fluid resulting from the cooling step is delivered into the container. The filled container is then optionally but preferably subjected to ambient temperature.

The process of the invention provides improved flexibility for the detergent formulator. The formulator is not confined in terms of viscosity of the fluids that will form part of the final product, he will formulate without taking into account the viscosity during the filling process because the process of the invention allows for temporary alteration of the viscosity of the detergent to optimise the filling process.

The rheology of the fluid would determine the degree of cooling required. Cooling should be above the freezing point of the fluid, preferably 2° C. above and more preferably 4° C. above the freezing point of the fluid. Otherwise the structure of the detergent can be altered when the fluid is defrosted.

The process of the invention is particularly suitable for the packing of low viscosity Newtonian fluids and for shear thinning fluids having low viscosity at high shear rate at ambient temperature. In the case of a Newtonian fluid, the fluid preferably has a viscosity of from about 100 mPa s to about 10,000 mPa s, more preferably from about 200 mPa s to about 8,000 mPa s and especially from about 300 mPa s to about 5,000 mPa s as measured at 20° C. using the method described herein below.

Shear thinning products are very appealing from a consumer viewpoint. Some consumers associate thickness of the product with high quality. A shear thinning product combines a thick appearance of the product within the container with easy pouring derived from the low viscosity at high shear rate. In the case of a shear thinning fluid, the fluid preferably has a high shear viscosity of from about 100 mPa s to about 10,000 mPa s, more preferably from about 200 mPa s to about 8,000 mPa s and especially from about 300 mPa s to about 5,000 mPa s as measured at 20° C. using the method described herein below. Preferably the fluid has a low shear viscosity of from about 10,000 mPas to 500,000 mPa s as measured at 20° C. using the method described herein below.

By “low viscosity” is herein meant a viscosity of from about 100 mPa s to about 10,000 mPa s, more preferably from about 200 mPa s to about 8,000 mPa s and especially from about 300 mPa s to about 5,000 mPa s as measured at 20° C. using the method described herein below.

By “high shear” is herein meant a shear rate of 10 s-1 and by “low shear” is herein meant a shear rate of 0.01 s-1 at 20° C. according to the method described here below.

In a preferred embodiment, the cooling takes places just before the finished fluid enters the delivery means, this is highly advantageous in the case in which the fluid or plurality of fluids are delivered from a single delivery means, such a single nozzle. This prevents in-nozzle mixing. This will also help in the case in which fluids are delivered from different delivery means because it can prevent splashing in the container that could result in in-container mixing. In one embodiment the fluids can be pre-combined in a tank before they enter the delivery means.

In other embodiment, the cooling takes places within the delivery means.

In the case of detergents comprising a plurality the fluids, more than one fluid can be cooled down at the same or different temperatures of the other fluids. In a preferred embodiment at least one of the plurality of fluids is cooled down to achieve the same viscosity as the remaining fluids. It has been found that when the viscosity and preferably the rheology of the plurality of fluids is matched (i.e. differs in less than 10%, more preferably less than 5% and especially less than 2%) better control of pattern generation during filing is achieved.

The plurality of fluids can be different in terms of composition or in terms of appearance. Preferred herein are visually distinctive fluids. It is very important to reduce intermixing with this kind of fluids, otherwise the appearance of the product is not very good.

The plurality of fluids can be delivered from a single or a plurality of delivery means. In the case of a plurality of visually distinctive fluids, they can have very attractive appearance. Different patterns can be achieved depending of the filling process. In a preferred embodiment the filling takes place under rotation. It can be done by rotating the container or by using rotating delivery means. Preferably the container is rotated during filling. The container is preferably filled from bottom to top being subjected to rotation, this can give rise to very attractive visual effects of the plurality of fluids. In a different embodiment the filling takes place under oscillation. This can be done by oscillating the container or the delivery means, preferred herein is oscillation of the container that can give rise to very attractive visual effects. The appearance of the packed detergent can be designed by adjusting the oscillation of the container during filling. Very attractive patterns can also be achieved by using a combination of rotation and oscillation during filing.

In the case of a plurality of fluids different patterns can be achieved such as to striped, marbled, rectilinear, interrupted stripes, check, mottled, veined, clustered, speckled, geometric, spotted, ribbons, helical, swirled, arrayed, variegated, textured, grooved, ridged, waved, sinusoidal, spiral, twisted, curved, cycle, streaks, striated, contoured, anisotropic, laced, weave or woven, tessellated, and combinations thereof. Each visually distinct fluid might be clear, translucent or opaque, and might comprise visible suspended particles, (micro)capsules or air bubbles. Typically these particles have a particle size of 10-5000 microns in length. Visually distinct may include, for example, fluids with different colors or uncolored, shades, opacities, inclusions or particles. This would not preclude the fluids from comprising two very similar compositions wherein one composition would only differ from the other by comprising a different level of colorant, opacifier, particles, (micro)capsules, air bubbles and other various (optional) ingredients.

The detergent composition used in the process of the invention preferably comprises a surfactant and preferably a rheology modifying agent, more preferably a structurant and especially an external structurant. More preferably, the detergent is a hand dishwashing detergent and the surfactant is a surfactant system comprising an anionic surfactant and an amphoteric surfactant. Preferably the anionic surfactant comprises an alkyl sulphate or alkyl ethoxysulphate or mixtures thereof and the amphotheric surfactant comprises an amine oxide.

### DETAILED DESCRIPTION OF THE INVENTION

The present invention is directed to a process for packing a detergent composition in a container. The detergent is in fluid form. The process involves the step of cooling the fluid before delivering it into the container. The process provides a multitude of benefits including avoidance of aeration, splashing and foam formation during packing and in the case of compositions comprising a plurality of fluids avoids intermixing of the different fluids during packing and storage.

The detergent composition of the invention is in fluid form, including pastes, gel, liquids, etc. Preferably the detergent is a hand dishwashing detergent.

The container is generally a bottle, preferably a bottle with a narrow neck. Preferably the container is transparent. Specially preferred for use herein are transparent containers containing two or more fluids. Preferably the container does not have internal divisions to separate different fluids.

The process of the invention can be carried out by making each fluid in a supply vessel. Supply vessels are typically stainless steel and are equipped with valves at their base wherein flow can be shut off to allow for changing such vessels without shutting down the processing equipment.

Connecting or supply lines are in communication with each fluids supply vessel. The supply lines can be in the form of hard or flexible piping such as stainless pipes or hoses, useful in transporting said fluids from their respective supply vessels. Said supply lines may be equipped with an inline pump from the supply vessel, thereby pressurizing the supply line to ensure consistent or steady flow from its connected supply vessel. Supply lines can be hard plumbed with an in-line pump, alternatively the supply lines can be under no pressure and the respective fluid can be fed from the supply vessel into a funnel.

Volumetric flow meters, and, or mass flow meters can be utilized to adjust the pumps to ensure constant flow. This can also be accomplished by utilizing metering type pumps to deliver the required volume or mass of each fluid.

The supply means would provide the fluids into the delivery means. The fluid or plurality of fluids would be cooled before entering or within the delivery means by for example using a heat exchanger. Examples of heat exchangers include tube in tube, shell and tube, plate and frame, spiral, Fin Fan and scraped wall. In terms of flow arrangement the heat exchanger can be a parallel-flow exchanger or a counter-current flow exchanger. The type of heat exchanger for use herein is determined by the degree and speed of cooling required.

The delivery means could be a single nozzle or a plurality of nozzles. The fluids can be combined by using a pre-combination tank.

Filling can be done using conventional filling equipment as that provided by Mengibar.

In a preferred embodiment the fluids are delivered under rotation. For example, a container can be secured into a puck or bottle holder. A rotating platform turns the container at a speed determined by a drive mechanism. The drive mechanism for the platform can be a variable speed mechanism or a constant speed mechanism. Alternatively rotation can be enabled by rotating at least one of the plurality of nozzles. In a preferred embodiment vertical relative movement of the delivering nozzle versus the container is enabled, i.e. at start of delivering the pre-packed fluid(s) the nozzle(s) is (are) close to the bottom of the container and then gradually move up as the liquid volume increases into the container. The container can be any suitable container for the product. Preferable containers are transparent PET bottles wherein the pattern of the finished composition is visible to the consumer.

The present invention covers a plurality of executions that can give rise to very attractive patterns in the case of a plurality the liquids. For example, the container can be filed with a first fluid and then a nozzle can be immersed on the first fluid and a second fluid can be delivered under either rotation, oscillation, vertical displacement or a mixture thereof. This kind of packing process gives rise to extremely visually appealing patterns. Appealing patterns can also be achieved by delivering two fluids simultaneously under different delivery conditions such as different speeds, different nozzle geometry or size, different kind of nozzle movement, etc.

The finished fluids herein can preferably be Newtonian or non-Newtonian. In the case of a Newtonian fluid the viscosity is preferably from 100 to 10,000 mPa s at 20° C.

In the case of non-Newtonian fluids, the finished fluid(s) are preferably shear thinning, more preferably having a high shear viscosity of from about 100 mPa s to about 10,000 mPa s, even more preferably from about 200 mPa s to about 8,000 mPa s and especially from about 300 mPa s to about 4,000 mPa s as measured at 20° C. In yet another embodiment, the shear thinning fluid has a low shear viscosity, as described in further detail herein, of between about 10,000 mPa s and about 500,000 mPa s, between about 100,000 mPa and about 400,000 mPa s and preferably between about 200,000 mPa s and about 300,000 mPa s.

Viscosity of shear thinning fluids can be determined by conventional methods, in particular using an AR G2 rheometer from TA instruments using a steel spindle at 40 mm diameter and a gap size of 500 μm. The low shear viscosity at 0.01 s-1, the medium shear viscosity at 0.1 s-1 and the high shear viscosity at 10 s-1 can be obtained from a logarithmic shear rate sweep at 20° C. The procedure consists of 3 steps including a pre-conditioning, a peak hold step at 0.01 s-1 and a flow ramp up from 0.01 s-1 to 100 s-1. The pre-conditioning step consists of a pre-shear at 10 s-1 for 30 s. The peak hold step at 0.01 s-1 follows immediately, taking a sample point every 10 s. The step reaches equilibrium if the viscosity of 8 consecutive sample points is within a 2% tolerance. The flow ramp up follows immediately and consists in shearing the sample at increasing shear rates in steady state flow mode from 0.01 to 100 s-1, for 5 points per decade on a logarithmic scale, allowing measurements to stabilize for a period of from 2 s for up to 20 s with a tolerance of 2 percent. The logarithmic plot of the viscosity vs. shear rate of the last step is used to determine the low shear viscosity at 0.01 s-1, the medium shear viscosity at 0.1 s-1 and the high shear viscosity at 10 s-1.

For consistency reasons, the viscosity of a Newtonian fluid is measured using the AR G2 rheometer used herein for a shear thinning fluid at a shear rate of 10 s-1.

The process of the invention allows for the creation of very attractive products in the case in which the detergent comprises a plurality of fluids. The fluids can have different rheology and appearances, for example a container can be filed with a thick paste in the middle forming a pattern, this pattern can be surrounding by a transparent shinny liquid. A great number of different detergent appearances that can be created with the process of the inventions, different fluid rheology, colours, textures, brightness, etc can be combined to produce different appearances.

The Detergent Composition

The detergent is suitable for any cleaning process including hand and automatic dishwashing, laundry, hard surface cleaning, etc. Preferably the detergent is a hand dishwashing detergent. Preferably the detergent is packed in a transparent bottle. It typically contains from 30% to 95%, preferably from 40% to 90%, more preferably from 50% to 85% by weight of a liquid carrier in which the other essential and optional components are dissolved, dispersed or suspended. One preferred component of the liquid carrier is water. The detergent composition of the process of the invention can be in the form of a single fluid or a plurality of fluids. In the case of a plurality of fluids the different fluids are chemically and/or visually distinct. Preferably the detergent comprises a plurality of visually distinct fluids.

Preferably the pH of the detergent is adjusted to between 3 and 14, more preferably between 4 and 13, more preferably between 6 and 12 and most preferably between 8 and 10. The pH of the detergent can be adjusted using pH modifying ingredients known in the art.

The detergent composition herein preferably comprises a surfactant system and more preferably a number of other optional ingredients such as builders, chelants, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic and inorganic cations such as alkaline earth metals such as Ca/Mg-ions and diamines, suds suppressors/stabilizers/boosters, antibacterial agents, preservatives and pH adjusters and buffering means.

The detergent composition of the process of the invention can comprise from about 5% to about 40%, preferably from about 8% to about 35% by weight thereof of a surfactant system. The surfactant system preferably comprises an alkoxylated anionic surfactant. The system can optionally comprise an amphoteric, non-ionic, zwitterionic, cationic surfactant and mixtures thereof.

Preferably, the surfactant system comprises alkyl sulfates and/or alkyl ethoxy sulfates; more preferably a combination of alkyl sulfates and/or alkyl ethoxy sulfates with a combined ethoxylation degree of less than 5, preferably less than 3, more preferably less than 2 and more than 0.5. Preferably, the composition of the present invention will further comprise amphoteric and/or zwitterionic surfactant, more preferably an amine oxide or betaine surfactant.

The most preferred surfactant system for the compositions of the present invention will therefore comprise: (i) 1% to 40%, preferably 6% to 32%, more preferably 8% to 25% weight of the total composition of an anionic surfactant (2) combined with 0.01% to 20% wt, preferably from 0.2% to 15% wt, more preferably from 0.5% to 10% by weight of the composition of amphoteric and/or zwitterionic and/or nonionic surfactant, more preferably an amphoteric and even more preferred an amine oxide surfactant. It has been found that such surfactant system will provide the excellent cleaning required from a hand dishwashing detergent while being very soft and gentle to the hands.

Nonionic surfactant, when present, is comprised in a typical amount of from 0.1% to 30%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol.

The detergent composition of the process of the invention can optionally comprise a viscosity modifier. The purpose of the viscosity modifier is to achieve the desired viscosity of the detergent composition when combined with the rest of the ingredients.

Preferably, the viscosity modifier is selected from the group consisting of electrolytes, organic solvents, and mixtures thereof. The detergent according to the invention, preferably comprise at least one electrolyte.

Electrolytes are water-soluble organic and inorganic salts (other than surfactants), wherein the cation is chosen from alkali metals, alkaline earth metals, ammonium and mixture thereof and the anion is chosen from chloride, sulfate, phosphate, acetate, nitrate and mixtures thereof. Particularly useful are potassium, sodium and ammonium chloride.

The amount of electrolyte should be sufficient to modify the viscosity of the detergent composition. A useful amount of electrolyte in the detergent composition is from 0.1% to 10%, more preferably from 0.15% to 5%, even more preferably from 0.2% to 3%, particularly from 0.25% to 2% by weight of the detergent.

Useful organic solvents to be added, preferably in addition to electrolytes, as viscosity modifiers are C1-C5 alkyl alcohols having one to three hydroxyl groups, and the concentration of said solvents is chosen so as to achieve the viscosity target. Other suitable organic solvents include C4-14 ethers and diethers, glycols and polymeric glycols such as polyethyleneglycol and polypropyleneglycol, alkoxylated glycols, C6-C16 glycol ethers, alkoxylated aromatic alcohols, aromatic alcohols, aliphatic branched alcohols, alkoxylated aliphatic branched alcohols, alkoxylated linear C1-C5 alcohols, amines, C8-C14 alkyl and cycloalkyl hydrocarbons and halohydrocarbons, and mixtures thereof. Also suitable for use herein as organic solvent are hydrotropes include anionic-type hydrotropes, particularly sodium, potassium, and ammonium xylene sulfonate, sodium, potassium and ammonium toluene sulfonate, sodium potassium and ammonium cumene sulfonate, and mixtures thereof. Preferred solvents are ethanol, (poly)propylene glycol and or cumene, toluene or xylene sulphonate hydrotropes, most preferably ethanol, propyleneglycol, polypropyleneglycol, and mixtures thereof, preferably each in an amount of 1% to 7% by weight of the detergent.

Colouring System

The fluid or fluids of the process of the invention can be of any colour, opaque or transparent. Preferably, in the case of a plurality of fluids, the fluids present different colours. Preferably the fluid or fluids of the process of the invention comprises a colouring system. The colouring system can comprise any opacifier or colorant. It has been found that better results in terms of colour stability occur when the colouring system comprise a colorant, opacifier or mixtures thereof. An opacifier according to the present invention is a solid, inert compound which does not dissolve in the composition and refracts, scatters or absorbs most light wavelengths. Suitable opacifiers have a refractive index (RI) substantially different from the system in which it is incorporated. The colour of a composition can be accurately and reliably measured using the Hunter L, a, b colour scale as detailed in WO2010/141301. The opacifier is preferably selected from the group consisting of styrene/acrylate latexes, titanium dioxide, Tin dioxide, any forms of modified TiO2, for example carbon modified TiO2 or metallic doped (e.g. Platinum, Rhodium) TiO2 or stannic oxide, bismuth oxychloride or bismuth oxychloride coated TiO2/Mica, silica coated TiO2 or metal oxide coated and mixtures thereof. Particularly preferred styrene/acrylate latexes are those available from the Rohm & Haas Company sold under the trademark Acusol.

The opacifier is preferably present in sufficient amount to leave the composition, in which it is incorporated, white. Where the opacifier is an inorganic opacifier (e.g. TiO2, or modifications thereof) the opacifier is preferably present at a level of from 0.001% to 1%, more preferably from 0.01% to 0.5%, most preferably from 0.05% to 0.15% by weight of the composition.

Where the opacifier is an organic opacifier (e.g. styrene/acrylate latexes), the opacifier is preferably present at a level of from 0.001% to 2.5%, more preferably from 1% to 2.2%, most preferably from 1.4% to 1.8% by weight of the composition.

As the term is used herein a “colorant” can be either a pigment or a dye depending on the vehicle in which it is used. In some instances, a pigment can be manufactured from a dye by precipitating a soluble dye with a metallic salt. The resulting pigment is called herein a lake pigment. In addition, it is generally accepted that there is a distinction usually made between a pigment, which is insoluble in the vehicle (resulting in a suspension), and a dye, which either is itself a liquid or is soluble in its vehicle (resulting in a solution). The term “biological pigment” is used herein for all colored substances independent of their solubility.

As the term is used herein a “pigment” is a material that changes the color of reflected light or transmitted of the phase. Such pigment can be natural, such as ultramarine blue, or synthetic, such as synthetic ultramarine pigment which is chemically identical to natural ultramarine. The pigment can be in powdered form. Preferred pigments are chemically inert and stable to UV, but fugitive pigment could be used to provide a color shift of the phases. Preferred pigments for use herein can be inorganic, organic or special pigments.

Naturally occurring pigments have been used as colorants since prehistoric times. The pigment for use herein can be a natural pigment, such as mica. It could also be a pigment from unusual sources such as botanical materials, animal waste, insects, and mollusks.

In accordance with another embodiment of the present invention, the pigment may be inorganic. Preferred inorganic pigments are the FDA approved pigment such as Blue 29 ultramarine, white 6 titanium oxide and white 18 calcium carbonate. Preferred organic pigments are FDA approved pigments such as blue 15 phthalocyanine and red 38 pyrazolone. In one embodiment of the present invention, inorganic food grade pigments such as E180, E171 and E172 and organic food grade pigment such as turmeric pigment may be used.

The colorant can be a dye. It is generally accepted that suitable dyes could be natural or synthetic. As the term is used herein a “dye” is a colored substance that has an affinity to the substrate to which it is being applied. Acid dyes and more specifically synthetic food colors are relevant to the present invention. Basic dyes are water-soluble cationic dyes, possibly complexed to anionic surfactant or polymers are also preferred for the present invention. When used direct dye could provide to the invention additional benefit as they are used as pH indicators.

Preferably, the dye can be selected from the group consisting of D&C Red 7; Red 57; Red 122; Red 405, 48:2; Red 206, 11, 49:2; Red 7, Red f4rh; Red 181, Red 226; Red B, Red 3, toluidine Red XL; Red 4, natural Red 4; Red 4, carmine; Red 150, Red 213, Red 4134; Solvent Red 139; Solvent Red 119; Natural yellow 5, curcumin; Pigment yellow 83; Iron pigment yellow 42, pigment 43; Japan yellow 201; Blue 15; Blue 66, blue 1, blue 6; Blue 29, ultramarine; Food Blue 4, blue 60; and mixtures thereof.

Water insoluble dyes are preferred to maintain good stability of the color in between the multiphase product. Preferred non water soluble dyes are Vat dyes are essentially insoluble in water and in acidic conditions. Disperse dyes were originally developed for the dyeing of cellulose acetate, and are water insoluble.

Reactive and azoic dyes are also encompassed herein, specifically if they are applied to micro/nano cellulosic matter or applied on non water soluble particles.

Most preferred are polymeric dyes. It is generally accepted that polymeric dyes are composed of optically chromophoric groups bound to or into polymers. They are classified as block type and graft type according to their structures. Either block polymeric dyes or graft polymeric dyes offer the advantage of allowing a range of physical properties, such as solubility, absorption, migration and viscosity that are tunable. The range of products possible offered by the joining of the fields of polymer chemistry and color chemistry is virtually inexhaustible. Polymeric water-soluble dyes, which are of considerable biological and technological interest because of their various properties including limited transfer from phase to phase. In addition they are generally described of being non absorbable.

To prepare water-soluble polymeric dyes constructed of fundamentally water-insoluble chromophores, the chromophore must somehow be attached to, or be made a part of, a polymeric system which otherwise contains the required solubilizing functionality.

Preferred polymeric dyes have pendent chromophore groups which are selected from azo, tricyanovinyl, anthraquinone, methine, and indoaniline groups.

External Structurant

Preferably the detergent composition comprises an external structurant. External structurants include microfibrillated celluloses, non-polymeric, hydroxyl-containing materials generally characterized as crystalline, hydroxyl-containing fatty acids, fatty esters and fatty waxes, such as castor oil and castor oil derivatives. It also includes naturally derived and/or synthetic polymeric structurants such as polycarboxylates, polyacrylates, hydrophobically modified ethoxylated urethanes, alkali soluble emulsions, hydrophobically modified alkali soluble emulsions, hydrophobically modified non-ionic polyols, cross-linked polyvinylpyrrolidone, polysaccharide and polysaccharide derivative type. Polysaccharide derivatives typically used as structurants comprise polymeric gum materials. Such gums include pectine, alginate, arabinogalactan (gum Arabic), carrageenan, gellan gum, xanthan gum and guar gum. Other classes of external structurants include structuring clays, amidogellants and fatty esters such as isopropyl myristate, isopropyl palmitate and isopropyl isostearate.

More preferably the detergent composition comprises crystalline external structurants such as non-polymeric hydroxyl-containing materials, microfibrillated celluloses and non-crystalline external structurants such as polymeric structurants selected from the group consisting of polyacrylates, polysaccharides, polysaccharide derivatives and mixtures thereof.

Reactive and azoic dyes are also encompassed herein, specifically if they are applied to micro/nano cellulosic matter or applied on non water soluble particles.

### EXAMPLES

Dual layer hand dishwashing liquids were prepared from two finished compositions (Phase 1 and Phase 2) having the formulas and viscosities displayed in Table 1. The finished compositions were simultaneously delivered into a 450 ml bottle in 6 seconds. The bottle was filled under rotation from bottom to top while applying 3 full revolutions and keeping, on average, a distance of 1 cm between the delivered liquids surface and nozzle's exit. The filing was done using a dual filler (MENGIBAR MULTI-STREAM PILOT FILLER, LLSA using 2 DM700 cylinders).

Phase 2 was delivered into seven containers at ambient temperature. Simultaneously Phase 1 was delivered into the seven containers at a different temperature in each container. The temperature ranged from 20° C. to 5° C., differing in 2.5° C. (20, 17.5, 15, 12.5, 10, 7.5 and 5° C.). Phase 1 was white opaque and Phase 2 was transparent blue. After the containers have been filled they were left to rest and then visually assessed. It was observed that in the case in which Phase 1 was delivered at 20° C. quite a bit of intermixing took place and the two phases could not be kept separate. Intermixing decreased with cooling and in the case in which Phase 1 was cooled to 5° C. the two phases were kept separated and intermixing was negligible.

TABLE 1

| | Phase 1 | Phase 2 |
|---|---|---|
| C12-13 AES | 17.6% | 17.6% |
| C12-14 dimethyl amine | 5.9% | 5.9% |
| oxide | | |
| Lutensol XP80 | 0.4% | 0.4% |
| Polypropyleneglycol | 0.5% | 0.1% |
| NaCl | 1% | 1% |
| Micro Fibrous Cellulose | 0.1% | 0.1% |
| Acusol 301 | 0.12% | |
| Pigmosol blue | | 0.002% |
| Water and minors | Balance to 100% | Balance to 100% |
| pH | 9.0 | 9.0 |
| High shear viscosity (10/s at | 3140 mPas | 3970 mPa s |
| 20° C.) | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process for packing a detergent composition in a container wherein the process comprises the steps of:
a) making the detergent composition in the form of a finished single fluid or a finished plurality of fluids;
b) cooling the finished single fluid or at least one finished fluid of the plurality of fluids to produce a cold fluid;
c) delivering the cold fluid resulting from step b) into the container using delivering means; and optionally
d) subjecting the filled container resulting from step c) to ambient temperature.

2. A process according to claim 1 wherein the single fluid or the at least one fluid of the plurality of fluids is cooled by at least about 2° C. and above its freezing point.

3. A process according to claim 1 wherein the single fluid is a Newtonian fluid having a viscosity of from about 100 to about 10,000 mPa s as measured at 20° C.

4. A process according to claim 1 wherein the single fluid or the at least one fluid of the plurality of fluids is shear thinning and has a high shear viscosity of from about 100 mPa s to about 10,000 mPa s as measured at 20° C.

5. A process according to claim 4 wherein the single fluid or the at least one fluid of the plurality of fluids has a low shear viscosity of from about 10,000 mPa s to about 500,000 mPa s as measured at 20° C.

6. A process according to claim 1 wherein the cooling takes place before the single fluid or the at least one fluid of the plurality of fluids enters the delivery means.

7. A process according to claim 1 wherein the cooling takes place within the delivery means.

8. A process according to claim 1 wherein the container is filled with a plurality of fluids and wherein at least one of the fluids is cooled down to achieve the same viscosity during filling as the remaining fluids of the plurality of fluids.

9. A process according to claim 1 wherein the container is filled with a plurality of fluids and wherein at least two fluids are visually distinct.

10. A process according to claim 1 wherein the fluid is delivered into the container under rotation, oscillation or mixtures thereof.

11. A process according to claim 1 wherein the fluids are delivered into the container under rotation, oscillation or mixtures thereof.

12. A process according to claim 1 wherein the single fluid or the at least one fluid of the plurality of fluids is delivered from the base to the top of the container.

13. A process according to claim 1 wherein the at least two fluids produce an interweaving visual effect.

14. A process according to claim 1 wherein the container is filled with a plurality of fluids using a multi-dosing nozzle.

15. A process according to claim 1 wherein the single fluid or the at least one fluid of the plurality of fluids comprises a colouring system selected from colorants, opacifiers and mixtures thereof.

16. A process according to claim 1 where in the composition comprises a surfactant system.

17. A process according to claim 1 wherein the composition comprises a structurant.

18. A process according to claim 17 wherein the structurant is an external structurant.
